(19) United States
(12) Patent Application Publication
(10) Pub. No.: US 2025/0088035 A1
(43) Pub. Date: Mar. 13, 2025

(54) DEVICE AND METHOD FOR CONTACTLESS INDUCTIVE POWER TRANSMISSION

(71) Applicant: Universität Stuttgart Körperschaft des öffentlichen Rechts, Stuttgart (DE)

(72) Inventors: Weizhou YE, Stuttgart (DE); Tobias GÖTZ, Stuttgart (DE); Nejila PARSPOUR, Stuttgart (DE)

(73) Assignee: Universität Stuttgart Körperschaft des öffentlichen Rechts, Stuttgart (DE)

(21) Appl. No.: 18/882,905

(22) Filed: Sep. 12, 2024

(30) Foreign Application Priority Data
Sep. 13, 2023 (DE) 10 2023 124 747.6

(51) Int. Cl. H02J 50/12; H02J 50/40; H02J 50/80

(52) U.S. Cl. CPC H02J 50/12; H02J 50/402; H02J 50/80

(57) ABSTRACT

A device for contactless inductive energy transmission having a first side and a second side is proposed, wherein the device comprises an energy transmission coil and a synchronisation coil, in each case, on the first side and on the second side. The energy transmission coils are in each case configured for inductive transmission and for receiving of energy, while the synchronisation coils are in each case configured for inductive transmission and for receiving a synchronisation signal, such that the first side and the second side are configured as a transmission side for contactless transmission of energy to be transmitted, and as a receiving side for contactless receiving of transmitted energy.

### RELATED APPLICATION

This application claims the benefit of priority of Germany Patent Application No. 10 2023 124 747.6 filed on Sep. 13, 2023, the contents of which are incorporated by reference as if fully set forth herein in their entirety.

### FIELD AND BACKGROUND OF THE INVENTION

The present invention relates to a device and to a method for contactless inductive energy transmission, according to the independent claims.

Contactless energy transmission by means of induction is known in principle from the prior art. In this case, a signal of a transmission side is converted into an alternating magnetic field, which is received on a receiving side by induction. The voltage induced in this way is directly related to the strength and the change of the magnetic field. In this case, an active rectifier circuit can be present on the receiving side, in order to convert the generated alternating volage into direct voltage.

Synchronising the actuation of the rectifier circuit on the receiving side with the alternation of the alternating field is also known in the prior art. This is achieved on the basis of the measured current strength on the receiving side, for which purpose, however, a complex and costly configuration is required. For example, a current measuring circuit having corresponding amplifiers and analogue-to-digital converters is required. Furthermore, there is a risk of instability of the wireless energy transmission system, due to the current synchronisation. For this reason alone, costly signal-processing algorithms must therefore be used as compensation.

### SUMMARY OF THE INVENTION

The object of the present invention is that of proposing a device and a method for contactless inductive energy transmission, which allows for efficient and cost-effective energy transmission.

The above-mentioned object is achieved by a device for contactless inductive energy transmission, wherein the device comprises a first side and a second side, wherein an energy transmission coil and a synchronisation coil are arranged on each side.

Each energy transmission coil is configured both for transmitting and also for receiving energy, while each synchronisation coil is configured for inductive transmission and for receiving of a synchronisation signal. In the present case, the energy to be transmitted or to be received is an energy signal. This can also include data, for example by superimposition. The synchronisation signal is also preferably an energy signal.

The energy is transmitted inductively. In detail, each energy transmission coil can generate an alternating magnetic field on the basis of an alternating current signal, and receive an alternating magnetic field and, on the basis of the received magnetic field, generate an alternating voltage signal.

Furthermore, the synchronisation signal is transmitted inductive. The synchronisation coils can generate an alternating magnetic field on the basis of an alternating current signal, and receive an alternating magnetic field and, on the basis of the received magnetic field, generate an alternating voltage signal.

Arranging both an energy transmission coil and a synchronisation coil on both sides makes it possible for each side to act as a transmission side for contactless transmission of energy to be transmitted, and as a receiving side for contactless receiving of transmitted energy. The roles of the transmission side, in other words the primary side, and the receiving side, in other words the secondary side, are thus not assigned to a specific side of the device, but rather can be freely selected. The separation between the primary side and the secondary side, or the transmission side and the receiving side, is removed, such that both sides of the device are provided symmetrically with a combination of a synchronisation coil and energy coil. The device is configured bidirectionally and allows for particularly flexible use.

In particular, the synchronisation coils each comprise a first side and a second side, wherein each synchronisation coil is formed such that a magnetic field generated on the first side has a different magnetic polarity from a magnetic field generated on the second side. In particular, each side can comprise at least one coil. The at least one coil of the two sides are arranged at least substantially in one plane and each surround one surface. This enclosed surface on each side can be configured to be at least substantially of the same size.

The synchronisation coil is in particular arranged in the corresponding magnetic field of the energy transmission coil of the same side of the device, such that in the case of energy transmission by means of the energy transmission coils on both sides of the synchronisation coil a magnetic voltage is induced and thus a current is generated. Each synchronisation coil can in particular be configured such that the voltage induced by the energy transmission coil of the same side is zero, i.e. the voltage components of the different sides balance one another. This serves for substantially reducing the influence of the energy transmission coil on the generated signal of the synchronisation coil, in other words the cross-talk, and thus for configuring the synchronisation more reliably. In this case, the surface enclosed by the coils of the different sides of the synchronisation coil can be adjusted by changing a width and/or a length of the coil in the corresponding plane, such that a voltage measured by a resistor is zero.

The first side and the second side of the device preferably each comprise a power electronic unit which is configured to convert a direct voltage signal on the transmission side into an alternating current signal, and to convert an alternating voltage signal on the receiving side into a direct voltage signal. The power electronic unit is preferably a converter. The power electronic unit of each side can thus assume both of the above-mentioned functions, depending on whether the respective side is configured as a receiving side or as a transmission side. Each power electronic unit can be configured as an active rectifier circuit, in particular as a full-bridge converter, comprising a plurality of switches. It above all comprises four switches, which can each be configured as a transistor. If the side functions as the receiving side, the power electronic unit acts as an active rectifier, while, if the side functions as the transmission side, the power electronic unit serves as the inverter.

The synchronisation signal, which is transmitted and received by means of the synchronisation coils, serves for synchronisation of control signals of the power electronic unit, i.e. control signals for actuating the power electronic unit, on the receiving side of the device with respect to control signals of the power electronic unit on the transmission side of the device. In particular, the synchronisation relates to a switching frequency of the power electronic unit on the receiving side with respect to a switching frequency of the power electronic unit on the transmission side. Synchronisation is thus achieved when the switching frequencies correspond and are thus identical.

In detail, the switches can be actuated using respective control signals, such that all the voltage parts of the alternating voltage signal enter into the direct voltage signal, and an efficient energy transmission takes place. Each control signal can be assigned to a switch. Specifically, the switches of each power electronic unit can be actuated alternately, depending on the corresponding alternating voltage, in order to take account of all the signal components. In other words, the control signals relate to the timepoints at which the switches of the power electronic unit are switched. Each switch can be assigned a switching sequence. This results as the inverse of the temporal spacing of successive control signals, with respect to said switch. Above all, the control signal for a switch on the receiving side is synchronised, with regard to its switching frequency, with the control signal of the switch on the transmission side, which is located at the same position of the power electronic unit, for example of the full-bridge converter. This applies for all the switches on the receiving side. Thus, while the actual switching timepoints of the switches on the transmission side and on the receiving side can be temporally offset, the frequency thereof after synchronisation is intended to be identical.

In particular, each side comprises a respective signal source for generating energy, preferably an energy signal, and a respective signal source for generating the synchronisation signal. The signal source for generating energy can be a simple voltage source. For generating the synchronisation signal, a circuit can be provided, which can comprise at least one digital-to-analogue converter and preferably an amplifier and/or a frequency filter and/or a crossover network, for example a diplexer or a duplexer. The digital-to-analogue converter can output a signal having different frequency components. The digital-to-analogue converter has an update rate fs, which specifies the frequency with which the output, i.e. the signal components of which the synchronisation signal is composed, is emitted. The synchronisation signal preferably consists of different frequency components. The frequency filters and/or crossover networks are optional components with which different frequency components can be interconnected or split. A system having such components on both sides offers the possibility of selecting which side is intended to serve as the reference for the synchronisation. Furthermore, the reciprocal and simultaneous synchronisation of both sides increases the frequency as well as the accuracy of the synchronisation.

Furthermore, each side can comprise a, preferably capacitive, compensation circuit, above all an LCC compensation circuit. This can above all comprise an inductive resistor and two capacitors, wherein the inductive resistor and the first capacitor are arranged in series with the energy transmission coil, and the second capacitor is arranged in parallel with the energy transmission coil. The second capacitor is thus arranged as a parallel capacitor, in parallel with the energy transmission coil. The compensation circuit serves to increase the coupling of the two energy transmission coils, and thus the efficiency of the transmission. In particular, the idle power is compensated.

Thus, preferably, the entire device is configured to be completely symmetrical, and serves as a bidirectional energy transmission system.

According to a further aspect, the invention relates to a method for contactless inductive energy transmission, wherein the method uses a device as described above. In particular in the case of the method, the first side is used as the transmission side and the second side is used as the receiving side, wherein a modulated periodic synchronisation signal S_{Tx} of the transmission side, for time periods following at spacings, is generated for the transmission side. These are in particular regular spacings. That is to say that temporally limited and mutually spaced time periods are present, in which a modulated periodic synchronisation signal is generated and inductively transmitted by means of the synchronisation coil.

In particular, the synchronisation signal S_{Tx} is modulated according to the following equation:

$${s}_{Tx} ( n + k \cdot {N}_{sync} ) = {s}_{Tx , basic} ( n ) für k ∈ [ 0 , {N}_{repeat} - 1 ] \qquad ( 1 )$$

$$wherein$$

$${s}_{Tx , basic} ( n ) = {\sum }_{i = 1}^{{M}_{f}} {A}_{i} sin ( {ω}_{i} \frac{n}{{f}_{s}} + {φ}_{i} ) for n ∈ [ 0 , {N}_{sync} - 1 ] \qquad ( 2 )$$

is to be understood as the base sequence.

In this case:
i stands for an index of different frequency components of the synchronisation signal,
M_{f} stands for the maximum number of frequency components,
Aᵢ stands for an amplitude of the ith frequency component,
ωᵢ stands for a frequency of the ith frequency component,
φᵢ stands for an initial phase of the ith frequency component,
fs stands for the update frequency,
n stands for n=t*fs with t as time,
N_{sync} stands for the temporal spacing between the repetitions of the base sequences,
Nᵣₑₚₑₐₜ stands for a maximum number of the base frequencies.

The base frequency S_{Tx, basic} thus repeats periodically. In other words, the synchronisation signal S_{Tx} consists of a sequence of base sequences, specifically the base sequence is repeated Nᵣₑₚₑₐₜ times. After Nᵣₑₚₑₐₜ repetitions, the sequence is completed, and a new sequence follows only in a next, temporally spaced time period. Pauses are provided between the time periods. Thus, a sequence can be output in each time period. The length of the synchronisation signal is preferably determined by half the period of the energy transmission signal.

The composition of the synchronisation signal from different frequency components is carried out above all in the digital range, and subsequently output via digital-to-analogue converters. If M_{f}=1, the synchronisation signal consists only of a sine wave, while in the case of M_{f}=2 it is already made up of two sine waves. fₛ is the sampling rate and corresponds to the update rate of the digital-to-analogue converter and states the frequency with which the output, i.e. the signal components of which the synchronisation signal is composed, is emitted. The sampling rate can be between 20 MHz and 80 MHz, for example 50 MHz.

The synchronisation signal S_{Tx} is converted by means of the digital-to-analogue converter on the transmission side into an alternating current signal, wherein an alternating magnetic field is generated by the synchronisation coil on the first side, on the basis of the alternating current signal. This is received by means of the synchronisation coil of the receiving side, and an alternating voltage signal is generated. Said alternating voltage signal corresponds to the synchronisation signal S_{Rx} of the receiving side.

The synchronisation signal S_{Rx} of the receiving side can be defined as follows:

$${s}_{Rx} ( n + k \cdot {N}_{sync} ) = {s}_{Rx , basic} ( n ) für k ∈ [ 0 , {N}_{repeat} - 1 ] \qquad ( 3 )$$

$$wherein$$

$${s}_{Rx , basic} ( n ) = {\sum }_{i = 1}^{{M}_{f}} {A}_{i}^{\#} sin ( {ω}_{i} \frac{n}{{f}_{s}} + {φ}_{i}^{\#} ) for n ∈ [ 0 , {N}_{sync} - 1 ] \qquad ( 4 )$$

is to be understood as the base sequence.

In particular, both the amplitude and the phase have changed through the near field and the inductive transmission, such that
Aᵢ^{#}stands for an amplitude of the ith frequency component, and
φᵢ^{#}stands for a shifted phase of the ith frequency component.

In detail, the transmitted and received signal changes by a voltage transfer function, which can bring about both a phase shift and an amplitude phase variation.

A synchronisation timepoint can now be determined by means of an autocorrelation function. The synchronisation timepoint serves to set back control signals of the power electronic unit of the receiving side, and thus synchronise them with control signals of the power electronic unit of the transmission side, with respect to the switching frequency. The control signals relate in particular to a switching frequency of the power electronic unit. Above all, the switches of the power electronic unit are actuated alternately, depending on the corresponding alternating voltage, in order to take account of all the signal components. In other words, the control signals relate to the timepoints at which the switches of the power electronic unit are switched, in order to synchronise these with the control signals of the transmission-side power electronic unit, and thus relate them to the same timepoint.

The synchronisation timepoint is in particular the temporal end of the synchronisation signal, i.e. the end of the sequence described above. As explained above, the synchronisation signal is transmitted for time periods that are temporally spaced. A corresponding end of the synchronisation signal, before a corresponding pause between the time periods occurs, can be determined by means of the autocorrelation function.

Above all, the autocorrelation function is used to determine an autocorrelation signal on the basis of the synchronisation signal of the receiving side. In this case, the course of the autocorrelation signal is observed. The autocorrelation signal will drop for a time period when the end of the synchronisation signal is reached, wherein this dropping can be ascertained. In particular, the signal can drop by a predefined threshold value. In detail, since the signal is repeated around the base sequence, the autocorrelation function will give a maximum that dies away upon reaching the end of the synchronisation signal of a time period.

Specifically, an autocorrelation signal S_{detection} can be determined on the basis of the synchronisation signal of the receiving side, by means of the following autocorrelation function:

$${s}_{detection} ( n ) = {\sum }_{m = 0}^{{N}_{sync} - 1} {s}_{Rx} ( n + m - {N}_{sync} ) \cdot {s}_{Rx} ( n + m ) \qquad ( 5 )$$

As can be seen from the equation, values of the synchronisation signal on the receiving side with a spacing of N_{sync} are compared with one another. Since N_{sync} is the spacing of the repetition, the autocorrelation function should be maximum, or at least constant, until the synchronisation signal drops.

If the values for S_{Rx} from equation 3 are inserted into equation 5, it can be seen that the autocorrelation signal S_{detection} in particular corresponds to the following equation:

$${s}_{detection} ( n ) = 2 \cdot {N}_{sync} \cdot {\sum }_{i = 1}^{{M}_{f}} {( {A}_{i}^{\#} )}^{2} für n ∈ [ {N}_{sync} , {N}_{sync} \cdot {N}_{repeat} - 1 ] \qquad ( 6 )$$

The autocorrelation signal thus corresponds to a fixed value, as long as the synchronisation signal does not drop.

In particular, the method can comprise a definition of a starting threshold value, a minimum time, and an end threshold value. The synchronisation timepoint can for example be identified when the autocorrelation signal drops below the end threshold value. The timepoint at which this condition is met can above all be defined as the synchronisation timepoint. Furthermore, the condition can be interpreted more strictly. The synchronisation timepoint can then be present if the autocorrelation signal exceeds a starting threshold value for at least a minimum time, and then falls below the end threshold value. Again, the synchronisation timepoint is the specific timepoint of the drop below the end threshold value.

In particular, the above-mentioned parameters can be defined or dynamically adjusted, if they were previously defined, on the basis of the autocorrelation signal of the sequence of a first time period at which the synchronisation signal is transmitted. As described above, equation 6 specifies the amplitude and thus a height of a platform of the autocorrelation signal, as long as the sequence continues. In particular, it is possible firstly to wait for a first time period of the transmission of the synchronisation signal, i.e. the first sequence. The amplitude of the autocorrelation signal, and thus the height of the corresponding platform, can then be determined, in order to define or dynamically adjust the above-mentioned parameters. For example, the parameters can be defined as follows:
Starting threshold value: 0.8*the last specified equation, specifically equation 6, Minimum time=0.5*N_{sync}/fₛ and
End threshold value=0.8*the last specified equation, specifically equation 6.

The parameters can thus be dynamically adjusted to the individual case and the specific application. In this case, the first synchronisation time period can be used not for synchronisation but rather for setting the parameters, and for example only the second time period, in other words the second sequence, and the following sequences are used for synchronisation.

The accuracy of the synchronisation is determined above all by the pulse width of the synchronisation signal. In particular, N_{sync} can be selected to be longer, in order to increase the accuracy of the synchronisation. In particular, N_{sync} can be at least 5, preferably at least 10, most preferably at least 16. Preferably, N_{sync} can be less than 30, preferably less than 25, most preferably less than 20.

In the present case, a synchronisation is achieved without the current strength of the second side being used for this purpose. Thus, the corresponding disadvantages of the instability and the costly and complex configuration for monitoring and compensating for the current strength are also omitted. The disadvantages result in particular from the fact that, on the secondary side, the current has an amplitude of several tens or even 100 amperes, and a correspondingly high frequency of up to 85 kHz or even up to several MHz. The corresponding components of the switching circuit have to be configured in a costly and thus complicated manner. Furthermore, in the prior art only synchronisation of the secondary voltage with the current on the receiving side can be ensured, but no direct synchronisation with the transmission side. Owing to the distortion due to bandwidth restrictions of the current transmitter, and the temporal delay for example due to corresponding analogue-to-digital converters, the current-based synchronisation is significantly less precise.

### BRIEF DESCRIPTION OF THE SEVERAL VIEWS OF THE DRAWINGS

In the figures, purely schematically

FIG. 1 shows a device for contactless inductive energy transmission;

FIG. 2 is a perspective view of the energy transmission coils and synchronisation coils of the device according to FIG. 1;

FIG. 3 is a detailed view of a circuit of the device of FIG. 1;

FIG. 4 is a time chart of the control signals of the transmission-side and reception-side power electronic unit;

FIG. 5 is an overview of an autocorrelation signal and the determination of the synchronisation timepoint; and

FIG. 6: is a process diagram of a method for contactless inductive energy transmission.

### DESCRIPTION OF SPECIFIC EMBODIMENTS OF THE INVENTION

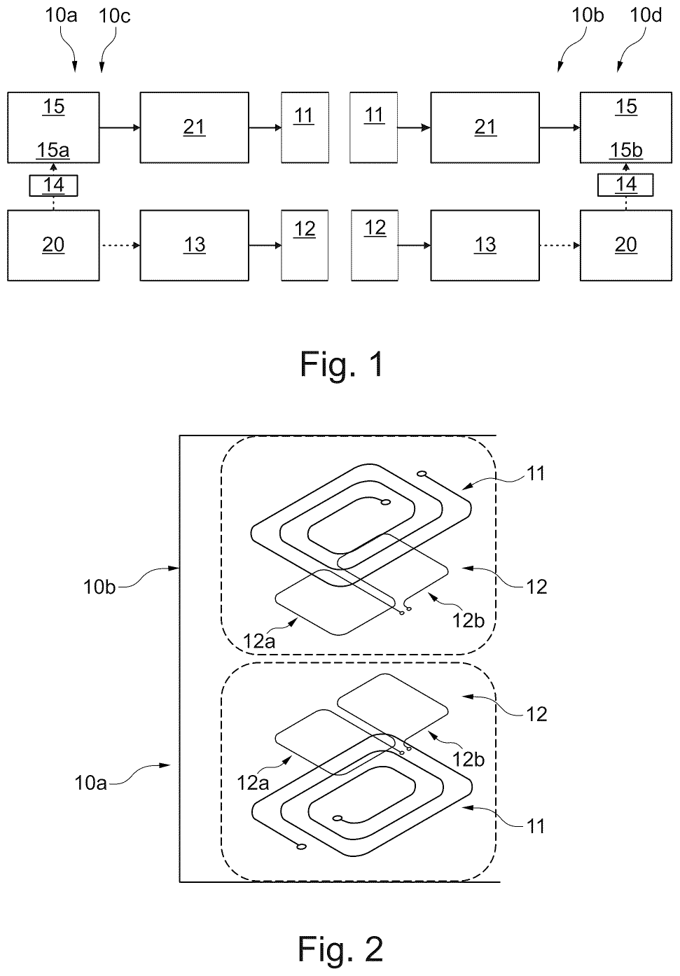

FIG. 1 shows a device 10 for contactless inductive energy transmission, wherein the device 10 comprises a first side 10a and a second side 10b. In the present case, the first side 10a functions as the transmission side 10c and the second side 10b functions as the receiving side 10d. However, both sides are configured such that they can act both as the transmission side and as the receiving side.

The device 10 comprises an energy transmission coil 11 and a synchronisation coil 12 on each side. Each side comprises a control unit 20. A signal source 14 for generating energy is provided on the first side 10a. This is a direct current signal, which is converted by means of a power electronic unit 15, which acts in the present case as an inverter 15a, into an alternating current signal. Said alternating current signal can reach the energy transmission coil 11 via a compensation circuit 21, wherein an alternating magnetic field is generated on the basis of the generated energy, which is inductively transmitted from the energy transmission coil 11 on the first side 10a to the energy transmission coil 11 on the second side 10b. The second side 10b has a compensation circuit 21, through which the signal passes until it is converted, by means of a power electronic unit 15 acting on the second side 10b as a rectifier 15b, into a direct voltage signal. A signal source 14 for generating energy is also provided on the second side 10b.

In the bottom half, FIG. 1 shows a circuit 13 for generating and receiving the synchronisation signal on both sides. In FIG. 1, the left-hand circuit 13 serves for generating the synchronisation signal, which is then inductively transmitted, by means of the synchronisation coil 12 of the first side 10a to the synchronisation coil 12 of the second side 10b, and is then received by the corresponding circuit 13 on the opposite side and forwarded to the control unit 20.

FIG. 2 is a perspective view of the corresponding coils of the device 10 according to FIG. 1 on both sides. Both an energy transmission coil 11 and a synchronisation coil 12 are arranged on the first side 10a and on the second side 10b. In this case, the synchronisation coil 12 is configured such that it has a first side 12a and a second side 12b, wherein the sides are configured such that a magnetic field generated on one side has a different magnetic polarity from a magnetic field generated on the other side. In particular, the windings are configured and arranged to form the energy transmission coil of the same side, such that in the case of energy transmission by means of the energy transmission coil a magnetic voltage is induced on both sides of the synchronisation coil, wherein the voltage components balance out.

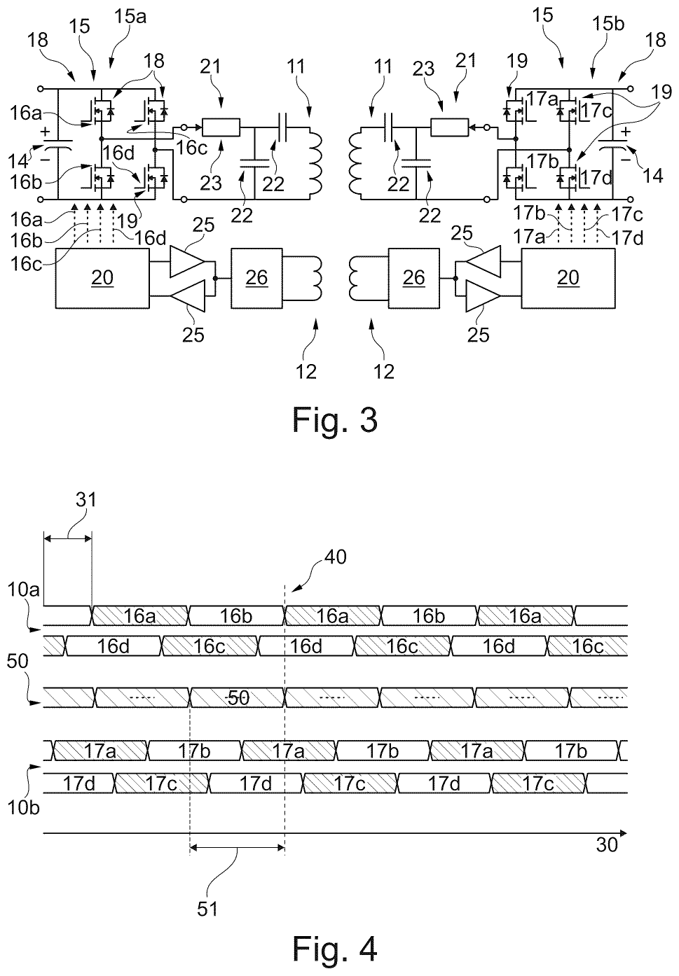

FIG. 3 shows a detailed view of a circuit of the device of FIG. 1. The signal source 14 for energy is clearly visible on each side. If it is assumed that, here, the first side 10a acts as the transmission side 10c, the signal source 14 generates energy which is converted by the power electronic unit 15, which acts here as an inverter 15a, into an alternating current signal. For this purpose, the power electronic unit comprises four switches 19, specifically transistors, and is configured as a full-bridge converter 18. The way in which control signals 16a, 16b, 16c and 16d from the control unit 20 actuate the power electronic unit 15, and specifically the individual switches 19, is clearly visible.

A compensation circuit 21 follows next, which comprises two capacitors 22 and an inductive resistor 23. One capacitor is connected in series with the inductive resistor 23 and the energy transmission coil 11, while a further capacitor 22 is connected in parallel with the energy transmission coil 11.

The energy transmission coil 11 follows next, which generates an alternating magnetic field which is then received by the energy transmission coil 11 of the second side 10b, wherein here, too, a compensation circuit 21 is configured analogously to the first side 10a. This, too, correspondingly comprises two capacitors 22 and an inductive resistor 23. The power electronic unit 15 of the second side 10b follows next, which acts here as a rectifier 15b. The control signals 17a, 17b, 17c and 17d for the power electronic unit 15 on the second side 10b are clearly visible again, which signals originate from the corresponding control unit 20 on the side.

The bottom side shows the circuit 13 for generating and receiving the synchronisation signal on both sides. This comprises at least one digital-to-analogue converter 25, and can further comprise a crossover network 26. The synchronisation signal consists of different frequency components. The synchronisation signal is transmitted, by means of the synchronisation coil 12 on the first side 10a, by induction, to the corresponding synchronisation coil 12 of the second side 10b. The same circuit 13 is located here.

The device 10 is configured to be completely symmetrical, such that the second side 10b can also act as the transmission side 10c and the first side 10a can also act as the receiving side 10d. It is therefore a bidirectional system.

FIG. 3 shows the corresponding control signals 16a, 16b, 16c, 16d of the power electronic unit of the first side 10a and the corresponding control signals 17a, 17b, 17c, 17d of the power electronic unit 15 of the second side 10b on a scale with respect to the time 30. These are associated with the individual switches 19.

It can clearly be seen that the signals are temporally offset with respect to the switch at the same point in the full-bridge converter, i.e. 16a to 17a, 16b to 17b, etc., specifically by an offset 31. The period of the energy results from the temporal spacing of two temporally successive control signals of the same switch (i.e. for example the spacing between two control signals 16a). The switching frequency can be determined from the spacing of identical neighbouring control signals. Thus, the inverse of the temporal spacing between two signals 16a corresponds to the switching frequency for the corresponding switch. This switching frequency is intended to be identical, after synchronisation, to that with respect to the corresponding switch on the transmission side, which corresponds to the inverse of the temporal spacing between second*TN signals 17a.

In the centre between the control signals, the synchronisation signal 50, which is received on the receiving side, is shown. Specifically, this is transmitted for a first time period 51 and received by the receiving side 10d.

It is now a question of determining the end of the synchronisation signal 50, and thus the end of the first time period 51, in order to ascertain the synchronisation timepoint 40. If the synchronisation timepoint 40 is determined, the power electronic unit 15 or the control signals 17a, 17b, 17, 17d thereof can be set back, such that these are then synchronous with the control signals 16a, 16b, 16c, 16d of the first side, with respect to the switching frequency. The time offset 31 thus does not interfere with the synchronisation, but rather the switching frequency between the signals of the transmission side 10c and of the receiving side 10d should be identical after the synchronisation.

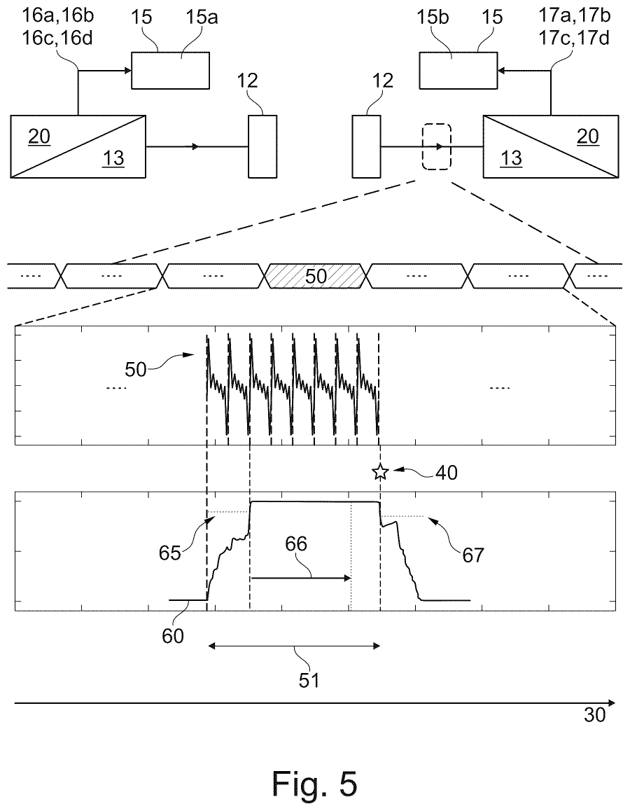

FIG. 5 shows an overview of an autocorrelation signal 60 and the determination of the synchronisation timepoint 40. Both are again plotted over time 30. It can again be seen, in the centre of the figure, how a synchronisation signal 50 is transmitted and received for a first time period 51. The synchronisation signal consists of 8 repeated sequences. An autocorrelation signal 60 is determined by means of an autocorrelation function, on the basis of the received synchronisation signal, which autocorrelation signal can be seen in the bottom graphs. The parameters of starting threshold value 65, minimum time 66 and end threshold value 67 are shown. It is clearly visible how the autocorrelation signal 60 rises above the starting threshold value, and specifically for longer than the minimum time 66, and then drops again below the end threshold value 67. These three parameters being fulfilled characterises the synchronisation timepoint which is used in the corresponding control unit 20 on the receiving side 10d for actuating the power electronic unit 15 of the second side.

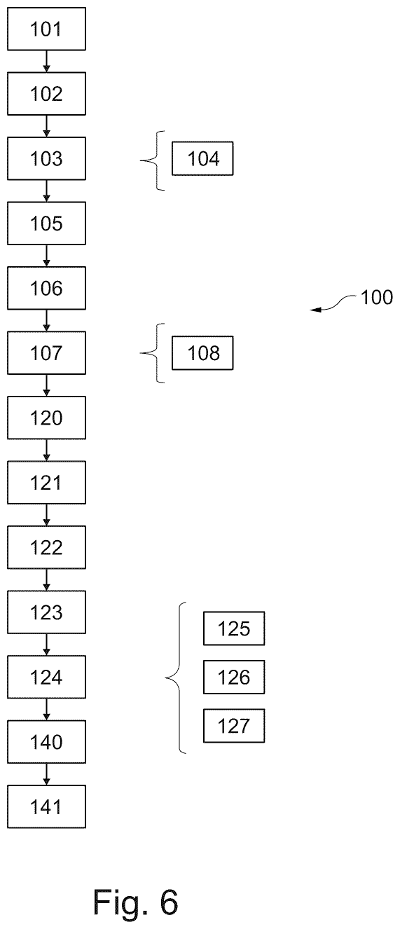

FIG. 6 shows a process scheme of a method 100 for contactless inductive energy transmission. The method 100 uses 101 a device described above. Firstly, energy is generated 102, and specifically by means of a corresponding signal source 14. The energy is converted 103 into an alternating current signal by means of a power electronic unit 15 on the transmission side 10c. For this purpose, the power electronic unit 15 is actuated 104 correspondingly, by means of corresponding control signals 16a, 16b, 16c, 16d. On the basis of the alternating voltage signal, an alternating magnetic field is generated 105 by means of the energy transmission coil 11 of the transmission side 10c, and received by means of the energy transmission coil 11 of the other side, and an alternating voltage signal is generated 106 on the basis of this. This alternating voltage signal is converted 107 into a direct voltage signal by means of a power electronic unit 15 on the receiving side 10d. For this purpose, the corresponding power electronic unit of the receiving side is actuated 108.

A synchronisation signal is generated 120, and on the basis of this an alternating magnetic field is generated 121 and received on the receiving side, and from this an alternating voltage signal is generated 122 by means of the corresponding synchronisation coils. An autocorrelation signal is generated 123 by means of an autocorrelation function, on the basis of the received synchronisation signal. A synchronisation timepoint 40 is determined 124 on the basis of the autocorrelation signal, and specifically an end threshold value can be defined 125 beforehand, furthermore a starting threshold value and a minimum time can be defined 126. These can also be dynamically adjusted 127. If the synchronisation timepoint 40 is determined 124, the control signals 17a, 17b, 17c, 17d of the power electronic unit 15 of the second side 10b can be set back 140, and thus the switching frequencies of the control signals of the two power electronic units of the different sides can be synchronised 141.

1. Device for contactless inductive energy transmission,
wherein
the device comprises a first side and a second side,
wherein the device comprises an energy transmission coil and a synchronisation coil, in each case, on the first side and on the second side,
wherein the energy transmission coils are in each case configured for inductive transmission and for receiving energy,
wherein the synchronisation coils are in each case configured for inductive transmission and for receiving a synchronisation signal,
such that the first side and the second side of the device are configured as a transmission side for contactless transmission of energy to be transmitted, and as a receiving side for contactless receiving of transmitted energy.

2. Device according to claim 1,
wherein
the synchronisation coils in each case comprise a first side and a second side,
wherein the synchronisation coils are in each case formed such that a magnetic field generated on the first side has a different magnetic polarity from a magnetic field generated on the second side.

3. Device according to either claim 1,
wherein
the first side and the second side in each case comprise a power electronic unit,
wherein the synchronisation signal serves for synchronisation of control signals of the power electronic unit on a receiving side of the device with respect to control signals of the power electronic unit on a transmission side of the device.

4. Device according to claim 3,
wherein
the power electronic units are configured as full-bridge converters having four switches.

5. Method for contactless inductive energy transmission,
wherein
the method uses a device according to claim 1.

6. Method according to claim 5,
wherein
the first side is used as the transmission side and the second side is used as the receiving side,
wherein on the transmission side a modulated periodic synchronisation signal S_{Tx} for time periods following at intervals is generated.

7. Method according to claim 6,
wherein
the synchronisation signal S_{Tx} is modulated according to the following equation:
$${s}_{Tx} ( n + k \cdot {N}_{sync} ) = {s}_{Tx , basic} ( n ) für k ∈ [ 0 , {N}_{repeat} - 1 ] \\ wherein \\ {s}_{Tx , basic} ( n ) = {\sum }_{i = 1}^{{M}_{i}} {A}_{i} sin ( {ω}_{i} \frac{n}{{f}_{s}} + {φ}_{i} ) for n ∈ [ 0 , {N}_{sync} - 1 ]$$
wherein
i is to be understood as an index of different frequency components of the synchronisation signal,
M_{f} as the maximum number of frequency components,
Aᵢ as an amplitude of the ith frequency component,
ωᵢ as a frequency of the ith frequency component,
φᵢ for an initial phase of the ith frequency component,
fₛ as the update frequency,
n as n=t*fₛ with t as time,
N_{sync} as the temporal spacing between the repetitions of the base sequences, and
Nᵣₑₚₑₐₜ as the maximum number of base sequences.

8. Method according to any of claim 5,
wherein
energy is generated on the first side,
wherein energy is converted into an alternating current signal by means of a power electronic unit on the first side,
wherein an alternating magnetic field is generated on the first side, on the basis of the alternating current signal, by means of the energy transmission coil,
wherein the energy transmission coil of the second side receives the alternating magnetic field and, on the basis thereof, generates an alternating voltage signal,
wherein the alternating voltage signal is converted into a direct voltage signal by means of a power electronic unit, on the second side.

9. Method according to any of claim 6,
wherein
wherein the synchronisation coil of the first side generates an alternating magnetic field on the basis of the synchronisation signal S_{Tx},
wherein the synchronisation coil of the second side receives the alternating magnetic field and, on the basis thereof, generates an alternating voltage signal,
wherein the alternating voltage signal corresponds to the synchronisation signal R_{Tx} of the receiving side.

10. Method according to claim 9,
wherein
the synchronisation signal R_{Tx} of the receiving side is defined as follows:
$${s}_{Rx} ( n + k \cdot {N}_{sync} ) = {s}_{Rx , basic} ( n ) für k ∈ [ 0 , {N}_{repeat} - 1 ]$$
wherein
$${s}_{Rx , basic} ( n ) = {\sum }_{i = 1}^{{M}_{f}} {A}_{i}^{\#} sin ( {ω}_{i} \frac{n}{{f}_{s}} + {φ}_{i}^{\#} ) for n ∈ [ 0 , {N}_{sync} - 1 ]$$
is to be understood as the base sequence,
wherein
Aᵢ^{#}stands for an amplitude of the ith frequency component, and
φₗ^{#}stands for a shifted phase of the ith frequency component.

11. Method according to either claim 9,
wherein
on the basis of the synchronisation signal R_{Tx} of the receiving side, an autocorrelation signal is generated by means of an autocorrelation function,
wherein a synchronisation timepoint is determined by means of the autocorrelation signal,
wherein at the synchronisation timepoint control signals of the power electronic unit of the receiving side are set back, and thus synchronised with the control signals of the power electronic unit of the transmission side.

12. Method according to claim 11,
wherein
the following is used as the autocorrelation function:
$${s}_{detection} ( n ) = {\sum }_{m = 0}^{{N}_{sync} - 1} {s}_{Rx} ( n + m - {N}_{sync} ) \cdot {s}_{Rx} ( n + m ) .$$

13. Method according to either claim 11,
wherein
the method comprises a definition of an end threshold value,
wherein the synchronisation timepoint is identified when the autocorrelation signal falls below the end threshold value.

14. Method according to claim 13,
wherein
the method comprises a definition of a starting threshold value and a minimum time,
wherein the synchronisation timepoint is identified when the autocorrelation signal exceeds the starting threshold value and falls below the end threshold value for at least the minimum time.

15. Method according to either claim 13,
wherein
the starting threshold value, the minimum time and the end threshold value are defined on the basis of the autocorrelation signal of a first time period.
